(19) United States
(12) Patent Application Publication
(10) Pub. No.: US 2013/0295280 A1
(43) Pub. Date: Nov. 7, 2013

(54) METHOD FOR COATING A SAMPLE

(71) Applicants: Vincent Fournee, Laitre-sous-Amance (FR); David Bonina, Dieulouard (FR); Samuel Kenzari, Andilly (FR)

(72) Inventors: Vincent Fournee, Laitre-sous-Amance (FR); David Bonina, Dieulouard (FR); Samuel Kenzari, Andilly (FR)

(73) Assignee: CENTRE NATIONAL DE LA RECHERCHE SCIENTIFIQUE, Paris (FR)

(21) Appl. No.: 13/980,468

(22) PCT Filed: Feb. 7, 2012
(86) PCT No.: PCT/FR2012/050263

§ 371 Date: Jul. 18, 2013

(30) Foreign Application Priority Data
Feb. 11, 2011 (FR) 11 51150

(51) Int. Cl. G01N 1/28

(52) U.S. Cl. CPC G01N 1/28
USPC 427/154; 106/205.9

(57) ABSTRACT

A method is provided for coating a sample with the help of a coating material, where the method includes coating material being obtained from a mixture of a polysaccharide powder as a gelling polymer and of a reinforcing powder that is a powder of a complex intermetallic alloy or a powder comprising a complex intermetallic alloy and at least one compound selected from a ceramic compound and a polymeric compound. The volume fraction of the reinforcing powder not exceeding 60% of the total volume of the mixture.

The present invention relates to a method of coating samples that makes it possible to simplify removing the coating from the samples. The method advantageously finds its application in preparing samples, e.g. in metallography where analyses require careful surface preparation by mechanical, mechanical-and-chemical, or chemical polishing.

The method of the invention also makes it possible to provide electrical conductivity, which can be useful for example when preparing a surface of the sample electrolytically. The method also makes it possible to coat and then cut/slice a sample that is difficult to handle or fragile.

The coating technique is used for making it easier to characterize a sample of material, for making a sample easy to handle in order to prepare its surface by polishing, or merely for making it possible to cut the sample. In particular, a sample may be coated with a coating resin that is in the form of granules or powder. Coating may be performed in a hot press, also known as a coater, in which a pressure force lying in the range (metric) tonne (t) to 60 t is applied on the coating material while it is raised to a temperature that is sufficient for densifying it. That temperature generally lies in the range 150° C. to 200° C., depending on the grade of coating resin used.

By way of example, the coating resin may be selected from resins sold under the name Multifast® by the supplier Struers, or indeed under the name PhenoCure® by the supplier Buehler. Such resins belong to the family of thermosetting polymers or indeed to the family of thermoplastic polymers.

It is known that the hot pressing of such coating resins makes it possible to obtain a coating that is sufficiently strong mechanically to be handled and that withstands abrasion sufficiently well to enable a surface of a sample of material to be prepared by polishing. However, no resin can be removed from the sample without damaging it, which means that the resin cannot be reused.

Document EP 0 246 438 describes a method of shaping metallic or ceramic compounds. That document does not describe a coating material obtained from a mixture that includes as a reinforcing powder a powder of a complex intermetallic alloy, and the teaching of that document does not enable surface preparation to be performed on a sample of material.

An object of the present invention is to remedy those drawbacks.

The method provides a simplified method that makes it possible to coat a sample of material and to remove the coating without any risk of spoiling the sample. In particular, the method uses a reusable coating material.

The invention thus provides a method of coating a sample with the help of a coating material, and in particular a not coating method.

In accordance with the invention, the coating material is obtained from a mixture of a polysaccharide powder as a gelling polymer and of a reinforcing powder that is a powder of a complex intermetallic alloy or a powder comprising a complex intermetallic alloy and at least one compound selected from a ceramic compound and a polymeric compound, the volume fraction of the reinforcing powder not exceeding 60% of the total volume of the mixture.

The method of the invention may thus include a step of shaping a composite powder constituted by a mixture comprising a powder of gelling polymer and at least one other powder serving to reinforce the polymer.

By way of example, it is possible to use a hot press coater for transforming a material in the form of a mixture of powders, the material comprising a mixture of galling polymer and of complex intermetallic powders or a mixture of complex intermetallic and ceramic powders or a mixture of complex intermetallic powders and polymeric powders, into a solid article by hot pressing.

The quantity of reinforcement is selected so that its volume fraction does not exceed 60% of the total volume of the material constituting the coating. Surprisingly, the Applicant has discovered that when the method is performed using a mixture of powder having this limited content of reinforcing powder, the coating material is easily removed and can be reused in full. The Applicant has also observed that by using a complex intermetallic reinforcing powder or a mixture of complex intermetallic and ceramic powders, the coating material presents mechanical properties, in particular in terms of wear and hardness, that are sufficient to make it possible to perform surface preparation. on a sample of material by polishing. The Applicant has also observed that when the method is performed with reinforcement comprising a complex intermetallic powder or a mixture of complex intermetallic powders, the electrical conduction properties are such as to make it possible to perform surface preparation of a sample of material electrolytically, without any need to remove the coating.

When a metallic sample is coated in a conventional resin, it is completely insulated electrically, which makes it impossible to prepare a surface electrolytically. The use of a conductive resin is a solution for mitigating that drawback. As conductive resin, it is possible to use the resins sold under the name ConduFast® from the supplier Struers, or indeed the resin sold under the name ProbeMet® by the supplier Buehler. Furthermore, the insulating nature of conventional coating material makes it difficult to characterize coated samples by electron microscopy, and it is even impossible to achieve optimum resolution without removing the resin and/or creating an electrical contact between the sample and the support plate by means of an adhesive based on copper or on carbon. Under such circumstances, observation of small, samples (less than 1 centimeter (cm)) is limited because of the small area. To mitigate that drawback, it is possible to use a conductive resin selected from the resins sold. under the name Polyfast® by the supplier Struers, or indeed the resin sold under the name KonductoMet® by the supplier Buehler. Nevertheless, the high cost of those resins limits their use. The solution in the most widespread use remains removing the coating resin with a saw or a chain saw at the risk of spoiling the sample, particularly if it is fragile.

The gelling polymer powder may be constituted by polysaccharide, such as for example a powder of galactose polymer known under the name agar-agar or agarose.

The polysaccharide is thus preferably a galactose polymer, such as agar-agar.

The reinforcing powder may comprise a powder of a complex intermetallic compound. comprising as its base (more than 50% in atomic percentage) at least one element selected. from iron, aluminum, copper, chromium, nickel, zinc, and titanium.

The reinforcing powder may also be a powder of one or more complex intermetallic alloys of one or more of those elements, without the elements having an atomic percentage greater than 50%.

The reinforcing powder may be mixture of one or more powders of complex intermeuallic alloys and one or more ceramic powders, or a mixture of one or more powders of complex intermetallic alloys and one or more polymeric powders. By way of example, the ceramic powder may be a powder of alumina (Al₂O₃), of silica (SiO₂), of aluminum nitride (AlN), of silicon carbide (SiC), of tungsten. carbide (WC), or a mixture thereof. In a preferred implementation, a ceramic content of less than 10% by volume is added to the metallic powder. The polymer powder may be a powder of a polymer selected from thermoplastic organic polymers such as polyamides (e.g. of the Nylon 6, Nylon 11, or Nylon 12 type), and copolymers of amide (e.g. Nylon 6-12).

The reinforcing powder is preferably a powder of a complex intermetallic alloy, in particular a complex. intermetaiiic alloy based on aluminum.

A complex intermetallic alloy may be a metallic alloy comprising an atomic percentage of aluminum that is greater than 50%.

In the present specification, the term “complex intermetallic alloy” designates an alloy having one or more quasi-crystalline phases that are either quasi-crystalline phases strictly speaking, or else approximant phases. Quasi-crystalline phases in the strict sense are phases presenting symmetries in rotation that are normally incompatible with symmetries in translation, i.e. symmetries of axis of rotation of order 5, 8, 10, or 12, these symmetries being revealed by diffraction techniques. By way of example, mention may be made of the icosahedral phase of m 3̅5̅ point groups and the decagonal phase of point group 10/mmm.

Approximant phases or approximant compounds are true crystals insofar as their crystallographic structure remains compatible with symmetry in translation, but in an electron diffraction shot they present diffraction patterns of symmetry close to symmetry of order 5, 8, 10, or 12. They are phases characterized by an elementary mesh containing several tens or even several hundreds of atoms, and in which local order presents arrangements of almost icosahedral or decagonal symmetry similar to the related quasi-crystalline phases.

Among these phases, mention may be made by way of example of the orthorhombic phase O₁, characteristic of an alloy of atomic composition Al₆₅Cu₂₀Fe₁₀Cr₅, having mesh parameters expressed in nanometers (nm) that are: a₀⁽¹⁾2.366, b₀⁽¹⁾=1.267, c₀⁽¹⁾=3.252. This orthorhombic phase O₁ is said to be approximant to the decagonal phase. The nature of the two phases can be identified by transmission electron microscopy.

Mention may also be made of the rhombohedral phase having the parameters a_{B}=3.208 nm, α=36°, that is present in alloys of atomic composition close to Al₆₄Cu₂₄Fe₁₂. This phase is an approximant phase of the icosahedral phase.

Mention may also be made of the orthorhombic phases O₂ and O₃ having respective parameters in nm: a₀⁽²⁾=3.83, b₀⁽²⁾=0.41, c₀⁽²⁾=5.26; and a₀⁽³⁾=3.25, b₀⁽³⁾=0.41, c₀⁽³⁾=9.8, that are present in an alloy of atomic composition Al₆₃Cu_{17.5}Co_{17.5}Si₂, or indeed the orthorhombic phase O₄ having parameters in nm of: a₀⁽⁴⁾=1.46, b₀⁽⁴⁾=1.23, c₀⁽⁴⁾=1.24 that forms in the alloy of atomic composition Al₆₃Cu₈Fe₁₂Cr₁₇.

Mention may also be made or a phase C of cubic structure that is observed very often to coexist with apuroxirnant or true quasi-crystalline phases. This phase, which forms in certain Al—Cu—Fe and Al—Cu—Fe—Cr alloys, consists in a suoerstructure, by a chemical, order effect of the elements of the alloy relative to the aluminum sites, of a phase having a structure of Cs—Cl type and a lattice parameter a₁=0.297 nm. A diffraction diagram of this cubic phase has been published for a sample of pure cubic phase and having an atomic cormoosition Al₆₅Cu₂₀Fe₁₅ in numbers of atoms.

Mention may also be made or a phase H of hexagonal structure that is derived directly from the phase C as demonstrated by the epitaxdal relationships observed by electron microscope between crystals of phases C and H and the simple relationships that link together the parameters of crystal lattices, namely a_{H}=3\sqrt{2}a₁/\sqrt{3} (to within 4.5%) and c_{H}=3\sqrt{3}a₁/\sqrt{2} (to within 2.5%). This phase is isotypical of a hexagonal phase, written ΦAlMn, that is found in Al—Mn alloys containing 40% by weight Mn.

The cubic phase, its superstructures, and the phases that derive therefrom, constitute a class of approximant phases of quasi-crystalline phases of similar compositions.

The quasi-crystalline alloys of the Al—Cu—Fe system are particularly appropriate for performing the method of the present invention. Mention may be made in particular of the alloys having any one of the following atomic compositions: Al₆₂Cu_{25.5}Fe_{12.5}, Al₅₉Cu_{25.5}Fe_{12.5}B₃, Al₇₁Cu_{9.7}Fe_{8.7}Cr_{10.6}, and Al_{71.3}Fe_{8.1}Co_{12.8}Cr_{7.8}. These alloys are sold by the supplier Saint-Gobain. In particular, the Al₅₉Cu_{25.5}Fe_{12.4}B₃ alloy is sold under the name Cristome F1, the Al₇₁Cu_{9.7}Fe_{8.7}Cr_{10.6} alloy is sold under the name Cristome A1, and the Al_{71.3}Fe_{8.1}Co_{12.8}Cr_{7.8} alloy is sold under the name Cristome BT1. These complex alloys have the advantage of possessing tribological properties (friction and wear), surface properties (low surface energy) , mechanical properties (hardness, elastic limit, and Young's modulus), thermal conductivity properties, and electrical properties (high resistivity) that are different from those of crystalline aluminum alloys.

The volume fraction of the reinforcing powder may lie in the range 40% to 60% of the total volume of the mixture.

The mixture of gelling polymer powder and of reinforcing powder may contain 40% to 80% by volume of gelling polymer, and more particularly 45% to 75%.

The volume fraction of the reinforcement may easily be calculated by the person skilled in the art from the weights and the densities of the various components of the mixture.

In the powder mixture used for performing the method, the polysaccharide and/or reinforcing particles preferably have a mean size lying in the range 1 micrometer (μm) to 1000 μm, and more particularly in the range 10 μm to 100 μm.

The method may include a step of heating the mixture in an aqueous solvent, typically water, to a temperature lying in the range 70° C. to 100° C., followed by a step of gelling the mixture by cooling the mixture down to a temperature of less than 70° C.

The method may also include a step of pressing the gelled mixture. The pressing step may be performed at a temperature lying in the range 70° C. to 100° C. The pressing step may also be performed at a pressure. lying in the range 5 megapascals (MPa) to 40 MPa.

In a preferred embodiment, the powder mixture is heated in water up to a temperature of about 100° C. for a few seconds. It is then cooled in ambient air (to the range 15° C. to 25° C.) The gelled mixture is then pressed at a temperature lying in the range 70° C. to 100° C. under a pressure lying in the range 5 MPa to 40 MPa.

The method may comprise the following steps:

preparing a mixture of a polysaccharide powder and of a reinforcing powder, which is a powder of a complex intermetallic alloy or a powder comprising a complex. intermetallic alloy and. at least one compound selected from a ceramic compound and a polymeric compound, the volume fraction of the reinforcing powder not exceeding 60% of the total volume of the mixture;

heating the mixture in an aqueous solvent up to a temperature higher than the solubilization temperature of the polysaccharide;

gelling the mixture by cooling the mixture so as to increase its viscosity; and

coating the sample by hot pressing so as to reduce the viscosity of the mixture around. the sample. The method. may also include a step of removing the coating from the sample by immersing the coating material in an aqueous solvent at a temperature higher than the solubilization temperature of the polysaccharide.

The method of the invention is particularly suitable for coating samples of material with the help of a hot press, such as for example a Labopress® or CitoPress® press as sold by the supplier Struers. The coating that is obtained presents mechanical properties, and in particular abrasion and harness properties that are compatible with surface preparation of a sample of material. The use of a gelling polymer also makes it possible to obtain a coating that is reusable and easily recyclable when it is used with a metallic reinforcing powder or a mixture of metallic powder and ceramic powder.

The present invention is described in greater detail with the help of the following examples, but the invention is nevertheless not limited thereto.

### EXAMPLE 1

### Coating, Separating, and Reusing the Coating

### Preparing the Powder

Composite powders were prepared comprising two different kinds of powder: an agar-agar powder with a powder of a complex intermetallic alloy; and an agar--agar powder with a reinforcing powder comprising a complex intermetallic alloy and at least one compound selected from a ceramic compound and a polymeric compound.

The reinforcing powders used were those described above. Each of the powders was weighed accurately so as to obtain an agar-agar volume fraction of 50%. The powders were preferably mixed in homogeneous manner with the help of a turbulat. About two to five minutes were necessary for mixing 200 grams (g) of powder.

### Preparing the Coating Material

A. composite material was prepared suitable for being used as a coating by adding a solvent to the mixture of powders at an agar-agar/solvent ratio of 0.2 (where measurements by weight or by volume are equivalent), the solvent being water in the preferred implementation.

### Coating a Sample of Material

Samples of a variety of materials such as iron, steel, cast iron, copper, brass, aluminum, and titanium were coated. The mechanical and abrasion properties enabled the surfaces of all those samples to be prepared mechanically.

Separating the Coating from the Sample of Material

The coatings of all of the above-mentioned samples were easily separated by immersing the samples in water raised to boiling point, i.e. about 100° C., for three to five minutes. It was possible to reuse all of the coating material obtained by the separation operation for reproducing this example.

### EXAMPLE 2

### Preparing a Surface Electrolytically

This example concerns obtaining a conductive coating material. The operating technique of Example 1 was repeated, but using metallic reinforcing powders. The metallic reinforcing powders were selected from complex intermetallic alloys based on aluminum. Only alloys based on crystalline aluminum did not produce a conductive coating. In contrast, when the alloys were selected from quasi-crystalline aluminums, the coating was conductive. It was possible for an aluminum alloy coated in a material constituted by gelled polymer and a mixture of iron and aluminum to be prepared electrolytically (polishing or etching). Conductive coatings were also prepared comprising a mixture of metallic and ceramic powders (40% Fe, 10% SiO₂) or metallic and polymeric powders (30% quasi-crystalline aluminums, 20% Nylon® 12 polyamide). The ConduFast® resin was used for coating a sample of aluminum alloy. It was possible to prepare its surface mechanically and electrolytically. Nevertheless, removing the coating by heating led to the resin being damaged (toxic and irritating vapors being given off, combustion) and the integrity of the prepared surface was degraded. It was not possible to separate the coating cleanly from the sample of material. Furthermore, it was not possible to envisage immediately reusing the coating, given that it had carbonized in part.

### EXAMPLE 3

### Preparing a Multilayer Coating

The same technique was used as in Example 1, but using a fine layer having a thickness of about 1 millimeter (mm) to 2 mm of conventional resin (thermosetting or thermoplastic, conductive or non-conductive) that was associated with one of the mixtures described in Example 1.

When the coating was to be conductive, the same procedure was used, but with one of the mixtures described in Example 2. Care was then taken to ensure that the layer of conventional resin did not exceed the height of the sample of material being prepared so that the material and the mixture were in contact. A coating was obtained having mechanical characteristics that enabled its surface to be prepared (mechanically, electrolytically, or chemically). Furthermore, the presence of a layer of conventional, resin made it possible to improve the edge effects associated. with mechanical preparation.

### EXAMPLE 4

### Preparing a Coating for Electron Microscopy

A conductive coating material was prepared using one of the mixtures described in Example 2 or in Example 3. Characterization by means of an electron microscope meant it was not possible for solvents to be present in the. coating. The solvent evaporated naturally at ambient temperature (lying in the range 15° C. to 25° C.) but the rate of evaporation. could be accelerated by heating in air for about ten minutes at a temperature higher than 100° C. The coating material was separated from the sample by reproducing the protocol of Example 1.

1. A method of coating a sample with the help of a coating material, said method comprising the steps of:
obtaining a coating material from a mixture of a polysaccharide powder as a gelling polymer and of
a reinforcing powder that is either one of a powder of a complex intermetallic alloy or a powder having a complex intermetallic alloy and
at least one compound selected from the group a ceramic compound and a polymeric compound,
wherein a volume fraction of the reinforcing powder not exceeding 60% of a total volume of the mixture.

2. A method according to claim 1, wherein the polysaccharide is a galactose polymer.

3. A method according to claim 2, wherein the galactose polymer is agar-agar.

4. A method according to claim 1, wherein the reinforcing powder is a powder of a complex intermetallic alloy.

5. A method according to claim 1, wherein the volume fraction of the reinforcing powder lies in the range 40% to 60% of the total volume of the mixture.

6. A method according to any one of claim 1, wherein the polysaccharide and/or reinforcing particles have a mean size lying in the range 1 μm to 1000 μm.

7. A method according to claim 6, wherein the polysaccharide and/or reinforcing particles have a mean size lying in the range 10 μm to 100 μm.

8. A method according to claim 1, wherein said method includes a step of heating the mixture in an aqueous solvent, at a temperature lying in the range 70° C. to 100° C. followed by a step of gelling the mixture by cooling the mixture to a temperature lower than 70° C.

9. A method according to claim 8, wherin the method further includes a step of pressing the gelled mixture.

10. A method according to claim 9, wherein the pressing step is performed at a temperature lying in the range 70° C. to 100° C.

11. A method according to claim 9, wherein the pressing step is performed at a pressure lying in the range 5 MPa to 40 MPa.

12. A method according to claim 1, wherein said method further comprises the following steps:
preparing a mixture of a polysaccharide powder and of a reinforcing powder, which is a powder of either one of a complex intermetallic alloy or a powder comprising a complex intermetallic alloy and at least one compound selected from the group consisting of a. ceramic compound and a polymeric compound, the volume fraction of the reinforcing powder not exceeding 60% of the total volume of the mixture;
heating the mixture in an aqueous solvent up to a temperature higher than the solubilization temperature of the polysaccharide;
gelling the mixture by cooling the mixture so as to increase its viscosity; and
coating the sample by hot pressing so as to reduce the viscosity of the mixture around the sample.

13. A method according to claim 12, wherein the reinforcing powder is a powder of a complex intermetallic alloy.

14. A method according to claim 12, wherein said method further includes a step of removing the coating from the sample by immersing the coating material in an aqueous solvent at a temperature higher than the solubilization temperature of the polysaccharide.
